(19) United States
(12) Patent Application Publication
(10) Pub. No.: US 2022/0303555 A1
(43) Pub. Date: Sep. 22, 2022

(54) COMBINING HIGH-QUALITY FOREGROUND WITH ENHANCED LOW-QUALITY BACKGROUND

(71) Applicant: Plantronics, Inc., Santa Cruz, CA (US)

(72) Inventors: Xi Lu, Beijing (CN); Yu Chen, Beijing (CN); Hai Xu, Beijing (CN); Tianran Wang, Beijing (CN); Hailin Song, Beijing (CN); Lirong Zhang, Beijing (CN)

(73) Assignee: Plantronics, Inc., Santa Cruz, CA (US)

(21) Appl. No.: 17/600,572

(22) PCT Filed: Jun. 10, 2020
(86) PCT No.: PCT/CN2020/095294

§ 371 Date: Sep. 30, 2021

(51) Int. Cl. H04N 19/167; H04N 19/124

(52) U.S. Cl. CPC H04N 19/167; H04N 19/124

(57) ABSTRACT

A method may include identifying, in a frame of a video feed, a region of interest (ROI) and a background, encoding the background using a first quantization parameter to obtain an encoded low-quality background, encoding the ROI using a second quantization parameter to obtain an encoded high-quality ROI, and encoding location information of the ROI to obtain encoded location information. The method may further include combining the encoded low-quality background, the encoded high-quality ROI, and the encoded location information to obtain a combined package. The method may further include transmitting the combined package to a remote endpoint.

### BACKGROUND

Observable video frame rate jitter and video quality degradation may occur during transmission of a large video frame, such as a reference frame that represents a complete image. However, simply reducing the frame size by image compression techniques has the drawback of also reducing image quality. Traditional image enhancement methods may increase image sharpness at the cost of amplified image noise, or may remove noise at the cost of degraded image quality and lost details. Thus, a capability for reducing frame size while preserving image quality would be useful.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, one or more embodiments relate to a method including identifying, in a frame of a video feed, a region of interest (ROI) and a background, encoding the background using a first quantization parameter to obtain an encoded low-quality background, encoding the ROI using a second quantization parameter to obtain an encoded high-quality ROI, and encoding location information of the ROI to obtain encoded location information. The method further includes combining the encoded low-quality background, the encoded high-quality ROI, and the encoded location information to obtain a combined package. The method further includes transmitting the combined package to a remote endpoint.

In general, in one aspect, one or more embodiments relate to a system including a camera and a video module. The video module is configured to identify, in a frame of a video feed received from the camera, a region of interest (ROI) and a background, encode the background using a first quantization parameter to obtain an encoded low-quality background, encode the ROI using a second quantization parameter to obtain an encoded high-quality ROI, encode location information of the ROI to obtain encoded location information, combine the encoded low-quality background, the encoded high-quality ROI, and the encoded location information to obtain a combined package, and transmit the combined package to a remote endpoint.

In general, in one aspect, one or more embodiments relate to a method including receiving, at a remote endpoint, a package including an encoded low-quality background, an encoded high-quality region of interest (ROI), and encoded location information, decoding the encoded low-quality background to obtain a low-quality reconstructed background, and applying a machine learning model to the low-quality reconstructed background to obtain an enhanced background. The method further includes decoding the encoded high-quality ROI to obtain a high-quality reconstructed ROI, decoding the encoded location information to obtain location information, and generating a reference frame by combining, using the location information, the enhanced background and the high-quality reconstructed ROI.

Other aspects of the invention will be apparent from the following description and the appended claims.

### BRIEF DESCRIPTION OF DRAWINGS

FIG. 1 shows an operational environment of embodiments of this disclosure.

FIG. 2, FIG. 3.1, and FIG. 3.2 show components of the operational environment of FIG. 1.

FIG. 4.1, FIG. 4.2, and FIG. 4.3 show flowcharts of methods in accordance with one or more embodiments of the disclosure.

FIG. 5, FIG. 6.1, and FIG. 6.2 show examples in accordance with one or more embodiments of the disclosure.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, although the description includes a discussion of various embodiments of the disclosure, the various disclosed embodiments may be combined in virtually any manner. All combinations are contemplated herein.

In the drawings and the description of the drawings herein, certain terminology is used for convenience only and is not to be taken as limiting the embodiments of the present disclosure. In the drawings and the description below, like numerals indicate like elements throughout.

A frame of a video feed is encoded as a reference frame that represents a complete image. The frame includes a region of interest (ROI) (e.g., the foreground) and a background area. Embodiments may encode the frame by encoding the ROI with high quality and encoding the background with low quality. Machine learning may be used when decoding the low quality background to enhance the quality of the background. Thus, despite being generated from a low-quality background, the decoded frame has high quality throughout the frame. The size of the encoded frame is reduced without incurring a noticeable loss of quality when the frame is decoded and/or displayed. By applying the machine learning to reference frames that represent a complete image, one or more embodiments reduce the computational overhead due to the application of machine learning.

Disclosed are systems and methods for combining high-quality foreground with enhanced low-quality background when encoding and decoding video frames. While the disclosed systems and methods are described in connection with a teleconference system, the disclosed systems and methods may be used in other contexts according to the disclosure.

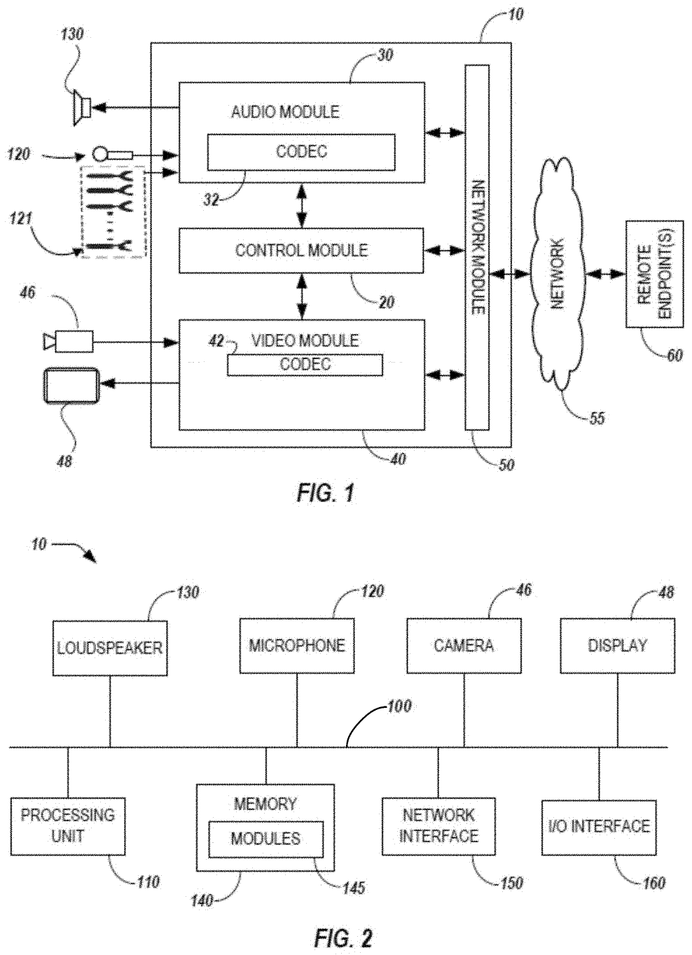

FIG. 1 illustrates a possible operational environment for example circuits of this disclosure. Specifically, FIG. 1 illustrates a conferencing apparatus or endpoint (10) in accordance with an embodiment of this disclosure. The conferencing apparatus or endpoint (10) of FIG. 1 communicates with one or more remote endpoints (60) over a network (55). The endpoint (10) includes an audio module (30) with an audio codec (32), and a video module (40) with a video codec (42). These modules (30, 40) operatively couple to a control module (20) and a network module (50). The modules (30, 40, 20, 50) include dedicated hardware, software executed by one or more hardware processors, or a combination thereof. In some examples, the video module (40) corresponds to a graphics processing unit (GPU), a neural processing unit (NPU), software executable by the graphics processing unit, a central processing unit (CPU), software executable by the CPU, or a combination thereof. In some examples, the control module (20) includes a CPU, software executable by the CPU, or a combination thereof. In some examples, the network module (50) includes one or more network interface devices, a CPU, software executable by the CPU, or a combination thereof. In some examples, the audio module (30) includes, a CPU, software executable by the CPU, a sound card, or a combination thereof.

In general, the endpoint (10) can be a conferencing device, a videoconferencing device, a personal computer with audio or video conferencing abilities, a mobile computing device, or any similar type of communication device. The endpoint (10) is configured to generate near-end audio and video and to receive far-end audio and video from the remote endpoints (60). The endpoint (10) is configured to transmit the near-end audio and video to the remote endpoints (60) and to initiate local presentation of the far-end audio and video.

A microphone (120) captures audio and provides the audio to the audio module (30) and codec (32) for processing. The microphone (120) can be a table or ceiling microphone, a part of a microphone pod, an integral microphone to the endpoint, or the like. Additional microphones (121) can also be provided. Throughout this disclosure, all descriptions relating to the microphone (120) apply to any additional microphones (121), unless otherwise indicated. The endpoint (10) uses the audio captured with the microphone (120) primarily for the near-end audio. A camera (46) captures video and provides the captured video to the video module (40) and video codec (42) for processing to generate the near-end video. For each video frame of near-end video captured by the camera (46), the control module (20) selects a view region, and the control module (20) or the video module (40) crops the video frame to the view region. In general, a video frame (i.e., frame) is a single still image in a video feed, that together with the other video frames form the video feed. The view region may be selected based on the near-end audio generated by the microphone (120) and the additional microphones (121), other sensor data, or a combination thereof. For example, the control module (20) may select an area of the video frame depicting a participant who is currently speaking as the view region. As another example, the control module (20) may select the entire video frame as the view region in response to determining that no one has spoken for a period of time. Thus, the control module (20) selects view regions based on a context of a communication session.

After capturing audio and video, the endpoint (10) encodes it using any of the common encoding standards, such as MPEG-1, MPEG-2, MPEG-4, H.261, H.263 and H.264. Then, the network module (50) outputs the encoded audio and video to the remote endpoints (60) via the network (55) using any appropriate protocol. Similarly, the network module (50) receives conference audio and video via the network (55) from the remote endpoints (60) and sends the audio and video to respective codecs (32, 42) for processing. Eventually, a loudspeaker (130) outputs conference audio (received from a remote endpoint), and a display (48) can output conference video.

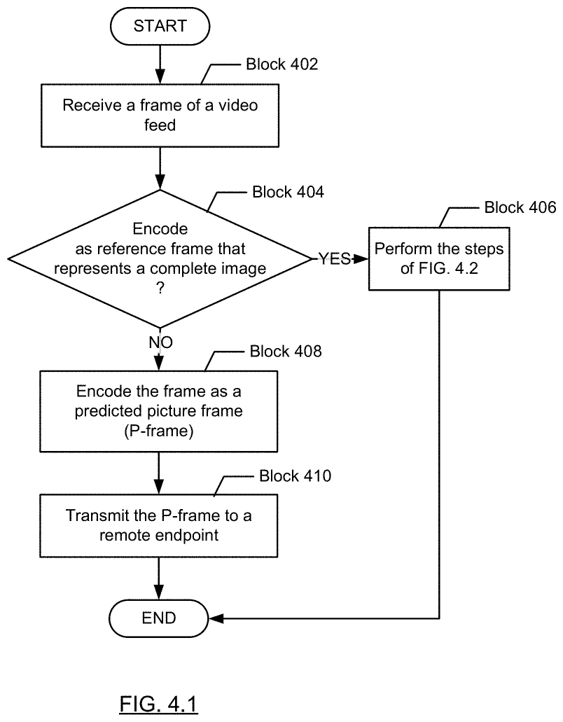

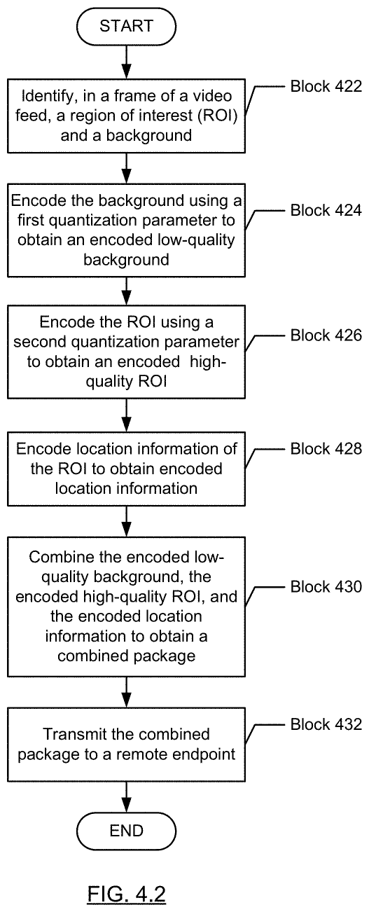

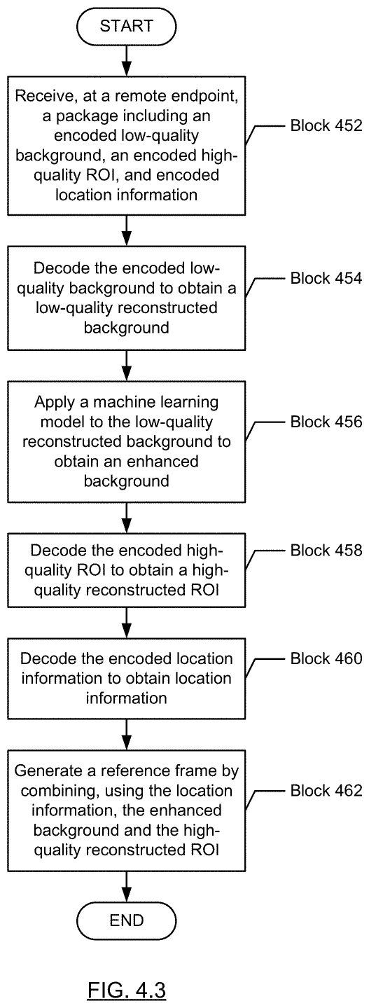

Thus, FIG. 1 illustrates an example of a device that combines high-quality foreground with enhanced low-quality background when encoding and decoding video captured by a camera. In particular, the device of FIG. 1 may operate according to one or more of the methods described further below with reference to FIG. 4.1, FIG. 4.2, and FIG. 4.3. As described below, these methods may reduce the size of an encoded video frame without incurring a noticeable loss of quality when the frame is decoded and/or displayed.

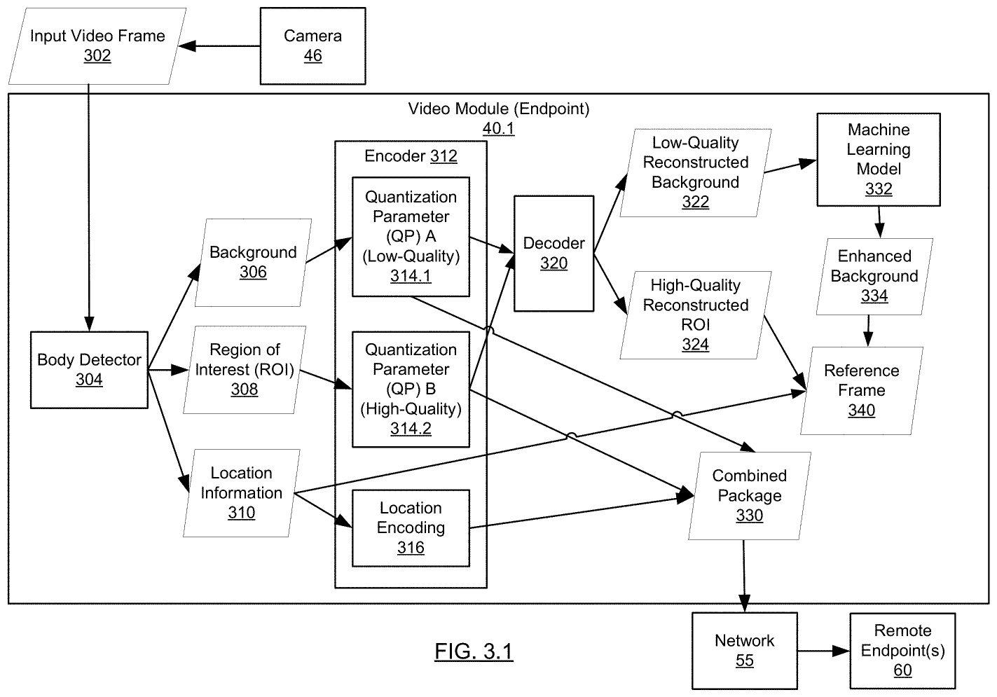

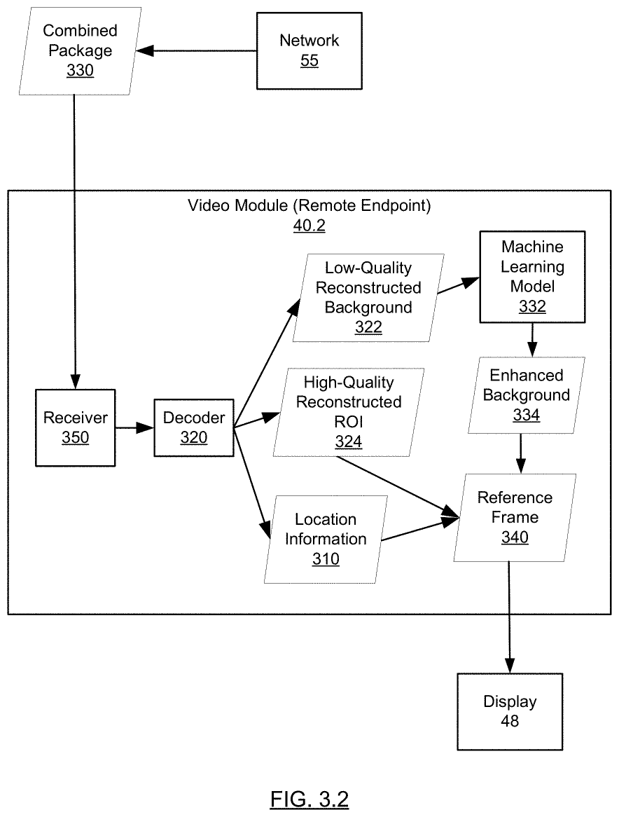

FIG. 2 illustrates components of the conferencing endpoint of FIG. 1 in detail. The endpoint (10) has a processing unit (110), memory (140), a network interface (150), and a general input/output (I/O) interface (160) coupled via a bus (100). As above, the endpoint (10) has the base microphone (120), loudspeaker (130), the camera (46), and the display (48).

The processing unit (110) includes a CPU, a GPU, an NPU, or a combination thereof. The memory (140) can be any conventional memory such as SDRAM and can store modules (145) in the form of software and firmware for controlling the endpoint (10). The stored modules (145) include the codec (32, 42) and software components of the other modules (20, 30, 40, 50) discussed previously. Moreover, the modules (145) can include operating systems, a graphical user interface (GUI) that enables users to control the endpoint (10), and other algorithms for processing audio/video signals.

The network interface (150) provides communications between the endpoint (10) and remote endpoints (60). By contrast, the general I/O interface (160) can provide data transmission with local devices such as a keyboard, mouse, printer, overhead projector, display, external loudspeakers, additional cameras, microphones, etc.

As described above, the endpoint (10) receives encoded video with a low quality background and decodes the encoded video without incurring a noticeable loss of quality. Thus, FIG. 2 illustrates an example physical configuration of a device that enhances a low-quality background when decoding video.

FIG. 3.1 shows a video module (40.1) of the endpoint (10). As shown in FIG. 3.1, the video module (40.1) includes functionality to receive an input video frame (302) from the camera (46). The input video frame (302) may be a video frame in a series of video frames captured from a video feed from a scene. For example, the scene may be a meeting room that includes the endpoint (10).

The video module (40.1) includes a body detector (304), an encoder (312), a decoder (320), and a machine learning model (332). The body detector (304) includes functionality to extract a background (306), a region of interest (ROI) (308), and location information (310) from the input video frame (302). The ROI (308) may be a region in the scene corresponding to a body (e.g., a person). Alternatively, the ROI (308) may be a region in the scene corresponding to any object of interest. The background (306) may be the portion of the scene external to the ROI (308). The location information (310) may be a representation of the location and size of the ROI (308) within the scene. For example, the location information (310) may define a bounding box enclosing the ROI (308). Continuing this example, the location information (310) may include the Cartesian coordinates of the top left corner of the bounding box, the width of the bounding box, and the height of the bounding box.

In one or more embodiments, the body detector (304) is implemented using a real-time object detection algorithm such as You Only Look Once (YOLO), which is based on a convolutional neural network (CNN). Alternatively, the body detector (304) may be implemented using OpenPose, a real-time multi-person system to detect two-dimensional poses of multiple people in an image.

The encoder (312) includes functionality to encode a video frame (e.g., input video frame (302)) in a compressed format. The encoder (312) includes functionality encode the background (306) using a low-quality quantization parameter (QP) (314.1) that corresponds to a low level of quality. The encoder (312) includes functionality to encode the ROI (308) using a high-quality QP (314.2) that corresponds to a high level of quality. Image quality may refer to the level of accuracy in which different imaging systems capture, process, store, compress, transmit and/or display the signals that form an image. In one or more embodiments, image quality is measured in terms of the level of spatial detail represented by the image. If two images share the same content, but one image has more spatial details, then the image with more spatial details has higher quality. The QP value regulates how much spatial detail is retained. When the QP value is small, more spatial details are retained. As the QP value increases, spatial details may be aggregated or omitted. Aggregating or omitting spatial details reduces the bitrate during image transmission, but may increase image distortion and reduce image quality.

A QP controls the amount of compression used in the encoding process. In one or more embodiments, the number of nonzero coefficients in a matrix used during the encoding of the frame depends on the QP value. The amount of information encoded is proportional to the number of nonzero coefficients in the matrix. For example, according to the H.264 encoding standard, a large QP value corresponds to fewer nonzero coefficients in the matrix, and thus the large QP value corresponds to a more compressed, low-quality image that represents fewer spatial details than the original image. Conversely, a small QP value corresponds to more nonzero coefficients in the matrix, and thus the small QP value corresponds to a less compressed, high-quality image. QP values may range between 0 and 51 in the H.264 encoding standard. The quality corresponding to a QP value may be relative. For example, a QP value of 36 may be high-quality relative to a QP value of 40. However, the QP value of 36 may be low-quality relative to a QP value of 32. The low-quality QP (314.1) may be defined in terms of the high-quality QP (314.2). For example, a low-quality QP value may be defined as a QP value that is less than a threshold percentage of a high-quality QP value. Conversely, a high-quality QP value may be defined as a QP value that is greater than a threshold percentage of a low-quality QP value.

The encoder (312) includes functionality to encode the location information (310) using a location encoding (316). For example, the location encoding (316) may be an encoding of the location information (310) as one or more messages. Continuing this example, the messages may be supplemental enhancement information (SEI) messages (e.g., as defined in the H.264 encoding standard) used to indicate how the video is to be post-processed.

Continuing with FIG. 3.1, the video module (40.1) includes functionality to combine the encoded low-quality background, the encoded high-quality ROI, and the encoded location information into a combined package (330). The structure of the combined package (330) may be defined by a schema indicating the positions of the encoded low-quality background, the encoded high-quality ROI, and the encoded location information in a specific sequence. For example, the specific sequence may be a sequence of fields in one or more messages to be transmitted to a remote endpoint (60). The video module (40.1) includes functionality to transmit the combined package (330) to one or more remote endpoints (60) via the network (55).

The decoder (320) includes functionality to decode encoded (e.g., compressed) video into an uncompressed format. The decoder (320) includes functionality decode the encoded low-quality background generated by the encoder (312) into a low-quality reconstructed background (322). For example, the low-quality reconstructed background (322) may be represented at the same low level of quality as the encoded low-quality background. Similarly, the decoder (320) includes functionality decode the encoded high-quality ROI generated by the encoder (312) into a high-quality reconstructed ROI (324). For example, the high-quality reconstructed ROI (324) may be represented at the same high level of quality as the encoded high-quality ROI.

The machine learning model (332) may be a deep learning model that includes functionality to generate an enhanced background (334) from the low-quality reconstructed background (322). The enhanced background (334) is a higher-quality representation of the low-quality reconstructed background (322). For example, the quality of the enhanced background (334) may be higher than the quality of the low-quality reconstructed background (322). The machine learning model (332) may be a Convolutional Neural Network (CNN) specially trained for video codec, that learns how to accurately convert low-quality reconstructed video to high-quality video. For example, the machine learning model (332) may use a single-image super-resolution (SR) method based on a very deep CNN (e.g., using 20 weight layers) and a cascade of small filters in a deep network structure that efficiently exploits contextual information within an image to increase the quality of the image. The quality of the enhanced background (334) may be comparable to the quality resulting from encoding the background (306) using the high-quality QP (314.2).

Continuing with FIG. 3.1, the video module (40.1) includes functionality to generate a reference frame (340) by combining, using the location information (310), the enhanced background (334) and the high-quality reconstructed ROI (324). A reference frame (340) may represent a complete image. For example, a reference frame (340) may be encoded and/or decoded without referring to any other frame. The reference frame (340) may be used to encode and/or decode subsequent video frames in a video feed. In contrast, a predicted picture frame (P-frame) may be encoded and/or decoded using data from another frame in the video feed. That is, a P-frame may represent a modification relative to another frame. For example, a P-frame may be encoded and/or decoded using a reference frame (340) preceding the P-frame in the video feed. Alternatively, the P-frame may be encoded and/or decoded using a previously received P-frame, or a subsequently received P-frame.

FIG. 3.2 shows a video module (40.2) of the remote endpoint (60). The video module (40.2) includes a receiver (350), a decoder (320), and a machine learning model (332). The receiver (350) includes functionality to receive a combined package (330) from the video module (40.1) of the endpoint (10) via the network (55). The receiver (350) includes functionality to extract, from the combined package (330), the encoded low-quality background, the encoded high-quality ROI, and the encoded location information. The receiver (350) includes functionality to send the encoded background, the encoded ROI, and the encoded location information to the decoder (320).

The video module (40.2) of the remote endpoint (60) may include functionality also provided by the video module (40.1) of the endpoint (10). For example, both the video module (40.1) and the video module (40.2) include a decoder (320) and a machine learning model (332). In addition, both the video module (40.1) and the video module (40.2) include functionality to generate a reference frame (340).

As described above, the decoder (320) includes functionality to decode the encoded low-quality background into a low-quality reconstructed background (322) and functionality to decode the encoded high-quality ROI into a high-quality reconstructed ROI (324). The decoder (320) included in the video module (40.2) further includes functionality decode the encoded location information into location information (310). For example, as described above, the encoded location information may include one or more SEI messages that describe the location information (310). As shown in FIG. 3.2, the video module (40.2) includes functionality to send a video frame (e.g., reference frame (340)) to the display (48).

FIG. 4.1 shows a flowchart in accordance with one or more embodiments of the invention. The flowchart depicts a process for encoding a video frame. One or more of the steps in FIG. 4.1 may be performed by the components (e.g., the video module (40.1) of the endpoint (10) and the video module (40.2) of the remote endpoint (60)), discussed above in reference to FIG. 3.1 and FIG. 3.2. In one or more embodiments of the invention, one or more of the steps shown in FIG. 4.1 may be omitted, repeated, and/or performed in parallel, or in a different order than the order shown in FIG. 4.1. Accordingly, the scope of the invention should not be considered limited to the specific arrangement of steps shown in FIG. 4.1.

Initially, in Block 402, a frame of a video feed is received. The video module of the endpoint may receive the video feed including the video frame from a camera.

If, in Block 404 a determination is made that the frame is to be encoded as a reference frame that represents a complete image, then in Block 406 the steps of FIG. 4.2 are performed. In one or more embodiments, the video module of the endpoint determines that the frame is to be encoded as a reference frame that represents a complete image in response to receiving an instantaneous decoder refresh (IDR) frame request. For example, the IDR frame request may be received from a remote endpoint. Continuing this example, the remote endpoint may send the IDR frame request when the video module of the remote endpoint is unable to decode a frame sent by the video module of the endpoint. Further continuing this example, the remote endpoint may send the IDR frame request in response to detecting network instability or corrupted data (e.g., a corrupted frame). Alternatively, the video module of the endpoint may determine that the frame is to be encoded as a reference frame based on detecting network instability or corrupted data.

Otherwise, if the video module of the endpoint determines that the frame is not to be encoded as a reference frame that represents a complete image in Block 404, then, in Block 408, the encoder of the video module encodes the frame as a predicted picture frame (P-frame) as a modification relative to a previously generated frame. For example, the previously generated frame may be a previously generated reference frame or a previously generated P-frame. By way of an example, the P-frame may capture the change in movements of a person in a conference call and not include unchanged background.

In Block 410, the P-frame is transmitted to a remote endpoint. The video module of the endpoint may transmit the P-frame to the remote endpoint via a network. In one or more embodiments, the video module of the endpoint receives an acknowledgment from the remote endpoint, via the network, indicating that the P-frame was successfully received. Alternatively, the video module of the endpoint may receive a message from the remote endpoint indicating that one or more P-frames were not received. For example, the one or more P-frames may have not been received due to network instability or packet loss.

FIG. 4.2 shows a flowchart in accordance with one or more embodiments of the invention. The flowchart depicts a process for encoding a video frame. One or more of the steps in FIG. 4.2 may be performed by the components (e.g., the video module (40.1) of the endpoint (10), and the video module (40.2) of the remote endpoint (60)), discussed above in reference to FIG. 3.1 and FIG. 3.2. In one or more embodiments of the invention, one or more of the steps shown in FIG. 4.2 may be omitted, repeated, and/or performed in parallel, or in a different order than the order shown in FIG. 4.2. Accordingly, the scope of the invention should not be considered limited to the specific arrangement of steps shown in FIG. 4.2.

Initially, in Block 422, a region of interest (ROI) and a background are identified in a frame of a video feed (see description of Block 402 above). The body detector of the video module includes functionality to extract the background and ROI from the frame. For example, the body detector may be implemented using a real-time object detection algorithm (e.g., based on a convolutional neural network (CNN)) or a real-time system to detect two-dimensional poses of multiple people in an image. For example, the ROI may be a bounding box enclosing an identified person.

In Block 424, the background is encoded using a first quantization parameter to obtain an encoded low-quality background. The first quantization parameter may have a large value. For example, according to the H.264 encoding standard, the output of a discrete cosine transform (DCT) used during the encoding process is a block of transform coefficients. During the encoding of the background, the encoder of the video module may quantize a block of transform coefficients by dividing each coefficient with an integer based on the value of the first quantization parameter. Setting the first quantization parameter to a large value results in a block in which many coefficients are set to zero, resulting in more compression and a low-quality image.

In Block 426, the ROI is encoded using a second quantization parameter to obtain an encoded high-quality ROI. The second quantization parameter may have a small value. During the encoding of the ROI, the encoder of the video module may quantize a block of transform coefficients by dividing each coefficient by an integer based on the value of the second quantization parameter. Setting the second quantization parameter to a small value results in a block in which few coefficients are set to zero, resulting in less compression and a high-quality image. (see description of Block 424 above).

Both the background and the ROI may be encoded with the same picture order count (POC). The POC determines the display order of decoded frames (e.g., at a remote endpoint), where a POC of zero typically corresponds to a reference frame.

In Block 428, location information of the ROI is encoded to obtain encoded location information. For example, the location information may be encoded as one or more supplemental enhancement information (SEI) messages that indicate post-processing instructions. Continuing this example, the post-processing may occur at the remote endpoint after the remote endpoint receives the combined package transmitted in Block 432 below.

In Block 430, the encoded low-quality background, the encoded high-quality ROI, and the encoded location information are combined to obtain a combined package. The video module may combine the low-quality background, the encoded high-quality ROI, and the encoded location information according to a schema that defines the positions of the encoded low-quality background, the encoded high-quality ROI, and the encoded location information in a specific sequence. In Block 432, the combined package is transmitted to a remote endpoint. The video module of the endpoint may transmit the combined package to the remote endpoint via a network.

The video module of the endpoint may generate, from the encoded low-quality background and the encoded high-quality ROI, a reference frame that has both a high-quality background, as well as a high-quality ROI. For example, there may be variations between the original background of the input video frame and the enhanced background generated by applying the machine learning model. Generating the reference frame by the same process at both the endpoint and the remote endpoint enables the same reference frame to be used by both the endpoint and the remote endpoint. The decoder of the video module may decode the encoded low-quality background to obtain a low-quality reconstructed background. The decoder may, as part of the process of decoding the encoded low-quality background, re-scale the quantized transform coefficients (described in Block 424 above) by multiplying each coefficient with an integer based on the value of the first quantization parameter in order to restore the original value of the coefficient. Thus, the low-quality reconstructed background may be represented at the same low level of quality as the encoded low-quality background. Next, the video module of the endpoint may apply the machine learning model to the low-quality reconstructed background to obtain an enhanced background with high-quality. In other words, the enhanced background is a higher-quality representation of the low-quality reconstructed background. Because the process described in FIG. 4.2 may be performed in response to a determination that the frame is to be encoded as a reference frame that represents a complete image (see description of Block 404 above), the machine learning model may be applied infrequently (e.g., when generating new reference frames), thus reducing the computational overhead of the video module.

The decoder may decode the encoded high-quality ROI to obtain a encoded high-quality reconstructed ROI. The decoder may, as part of the process of decoding the encoded high-quality ROI, re-scale the quantized transform coefficients (described in Block 426 above) by multiplying each coefficient with an integer based on the value of the second quantization parameter in order to restore the original value of the coefficient. Thus, the high-quality reconstructed ROI may be represented at the same high level of quality as the encoded high-quality ROI.

The video module of the endpoint may then generate a reference frame that has a high-quality background, as well as a high-quality ROI by combining the enhanced background and the high-quality reconstructed ROI using the location information. Thus, despite being generated from a low-quality background, the reference frame has high quality throughout the frame—in the enhanced background and in the high-quality reconstructed ROI. The encoder may then encode a subsequently received frame in the video feed as a P-frame as a modification relative to the reference frame (see description of Block 408 above).

If the frame was received in response to an IDR frame request (see description of Block 404 above), then after generating the reference frame, the video module of the endpoint may flush the contents of a reference frame buffer and add the reference frame to the reference frame buffer to ensure that no previously generated reference frame is used to encode a subsequently received frame as a predicted picture frame (P-frame).

FIG. 4.3 shows a flowchart in accordance with one or more embodiments of the invention. The flowchart depicts a process for decoding a frame. One or more of the steps in FIG. 4.3 may be performed by the components (e.g., the video module (40.1) of the endpoint (10), and the video module (40.2) of the remote endpoint (60)), discussed above in reference to FIG. 3.1 and FIG. 3.2. In one or more embodiments of the invention, one or more of the steps shown in FIG. 4.3 may be omitted, repeated, and/or performed in parallel, or in a different order than the order shown in FIG. 4.3. Accordingly, the scope of the invention should not be considered limited to the specific arrangement of steps shown in FIG. 4.3.

Initially, in Block 452, a package including an encoded low-quality background, an encoded high-quality region of interest (ROI), and encoded location information is received at a remote endpoint. The remote endpoint may extract the low-quality background, the encoded high-quality ROI, and the encoded location information using a schema for the package that defines the positions of the encoded low-quality background, the encoded high-quality ROI, and the encoded location information in a specific sequence. The remote endpoint may receive the package (e.g., the combined package transmitted in Block 432 above) from the video module of the endpoint over a network.

In Block 454, the encoded low-quality background is decoded to obtain a low-quality reconstructed background. The decoder of the remote endpoint may, as part of the process of decoding the encoded low-quality background, re-scale the quantized transform coefficients (described in Block 424 above) by multiplying each coefficient with an integer based on the value of the first quantization parameter in order to restore the original value of the coefficient.

In Block 456, a machine learning model is applied to the low-quality reconstructed background to obtain an enhanced background. That is, the enhanced background is a higher-quality representation of the low-quality reconstructed background.

In Block 458, the encoded high-quality ROI is decoded to obtain a high-quality reconstructed ROI. The decoder may, as part of the process of decoding the encoded high-quality ROI, re-scale the quantized transform coefficients (described in Block 426 above) by multiplying each coefficient with an integer based on the value of the second quantization parameter in order to restore the original value of the coefficient.

In Block 460, the encoded location information is decoded to obtain location information. For example, the encoded location information may be represented as one or more supplemental enhancement information (SEI) messages that describe the location information.

In Block 462, a reference frame is generated by combining, using the location information, the enhanced background and the high-quality reconstructed ROI. The location information indicates the positioning of the ROI relative to the background. The result of combining the enhanced background and the high-quality reconstructed ROI using the location information may be a reference frame that has a high-quality background, as well as a high-quality ROI. Thus, despite receiving a package including a low-quality background, the generated reference frame has high quality throughout the frame. The process by which the remote endpoint generates the reference frame is equivalent to the process by which the endpoint generates the reference frame. Thus, any P-frames transmitted by the endpoint encoded as a modification relative to a reference frame may be decoded correctly by the remote endpoint.

If the package was received in Block 452 above in response to an IDR frame request (see description of Block 404 above), then after generating the reference frame, the remote endpoint may flush the contents of a reference frame buffer and add the reference frame to the reference frame buffer to ensure that no previously generated reference frame is used to decode a subsequently received frame as a P-frame.

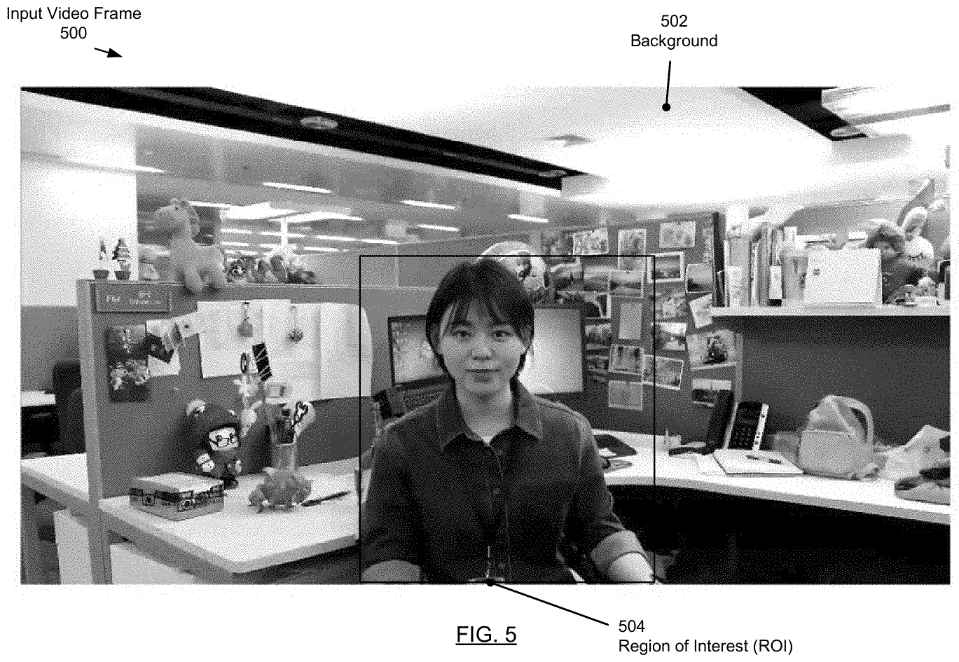

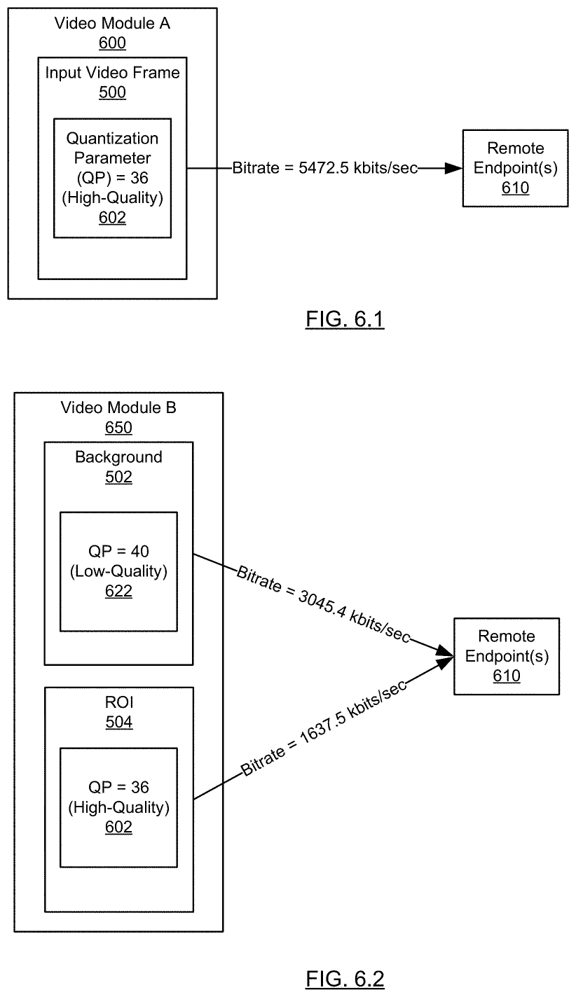

FIG. 5, FIG. 6.1, and FIG. 6.2 show an implementation example(s) in accordance with one or more embodiments. The implementation example(s) are for explanatory purposes only and not intended to limit the scope of the invention. One skilled in the art will appreciate that implementation of embodiments of the invention may take various forms and still be within the scope of the invention.

FIG. 5 shows an input video frame (500) ((302) in FIG. 3.1) received at an endpoint from a camera. The input video frame (500) includes a region of interest (ROI) (504) ((308) in FIG. 3.1) enclosed by a bounding box. The bounding box is described by location information that includes the height and width of the bounding box, and the Cartesian coordinates of the top left corner of the bounding box. The background (502) ((306) in FIG. 3.1) is the portion of the input video frame (500) external to the ROI (504).

FIG. 6.1 shows video module A (600) which encodes the input video frame (500) using a high-quality quantization parameter (QP) (602) ((314.2) in FIG. 3.1). FIG. 6.1 represents the conventional approach where the entire input video frame (500) is encoded using high quality. Video module A (600) transmits the encoded input video frame to one or more remote endpoints (610) ((60) in FIG. 1, FIG. 3.1, and FIG. 3.2) at a bitrate of 5472.5 kilobits per second.

In contrast, FIG. 6.2 shows video module B (650) ((40.1) in FIG. 1 and FIG. 3.1) which encodes the background (502) of the input video frame (500) using a low-quality QP (622) ((314.1) in FIG. 3.1) and encodes the ROI (504) of the input video frame (500) using the high-quality QP (602). Video module B (650) transmits the encoded low-quality background to one or more remote endpoints (610) at a bitrate of 3045.4 kilobits per second and transmits the encoded high-quality ROI at a bitrate of 1637.5 kilobits per second. Thus, the bitrate used by video module B (650) represents an approximately 14.43% reduction relative to the bitrate used by video module A (600). The bitrate reduction achieved by video module B (650) relative to video module A (600) depends on the size of the ROI (504). For example, the bitrate reduction is larger when the size of the ROI (504) is small relative to the size of the input video frame (500).

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method comprising:
identifying, in a first frame of a video feed, a region of interest (ROI) and a background;
encoding the background using a first quantization parameter to obtain an encoded low-quality background;
encoding the ROI using a second quantization parameter to obtain an encoded high-quality ROI;
encoding location information of the ROI to obtain encoded location information;
combining the encoded low-quality background, the encoded high-quality ROI, and the encoded location information to obtain a combined package; and
transmitting the combined package to a remote endpoint.

2. The method of claim 1, further comprising:
decoding the encoded low-quality background to obtain a low-quality reconstructed background; and
applying a machine learning model to the low-quality reconstructed background to obtain an enhanced background.

3. The method of claim 2, further comprising:
decoding the encoded high-quality ROI to obtain a high-quality reconstructed ROI; and
generating a reference frame by combining, using the location information, the enhanced background and the high-quality reconstructed ROI.

4. The method of claim 3, further comprising:
encoding a second frame of the video feed as a modification to the reference frame to obtain an encoded second frame, wherein the second frame follows the first frame in the video feed; and
transmitting, to the remote endpoint, the encoded second frame.

5. The method of claim 4, further comprising:
decoding, at the remote endpoint, the encoded second frame as the modification to the reference frame to obtain the second frame; and
displaying, at the remote endpoint and based on decoding the encoded second frame as the modification to the reference frame, the second frame.

6. The method of claim 3, further comprising:
receiving a request to generate an instantaneous decoder refresh (IDR) frame, wherein the ROI and the background are identified in the first frame in response to receiving the request.

7. The method of claim 6, further comprising:
after receiving the request, flushing the contents of a reference frame buffer; and
after flushing the contents of the reference frame buffer, adding the reference frame to the reference frame buffer.

8. The method of claim 1, further comprising:
receiving, at the remote endpoint, the combined package comprising the encoded low-quality background, the encoded high-quality ROI, and the encoded location information;
decoding, at the remote endpoint, the encoded low-quality background to obtain a low-quality reconstructed background;
decoding, at the remote endpoint, the encoded high-quality ROI to obtain a high-quality reconstructed ROI; and
decoding, at the remote endpoint, the encoded location information to obtain the location information.

9. A system comprising:
a camera; and
a video module configured to:
identify, in a first frame of a video feed received from the camera, a region of interest (ROI) and a background,
encode the background using a first quantization parameter to obtain an encoded low-quality background,
encode the ROI using a second quantization parameter to obtain an encoded high-quality ROI,
encode location information of the ROI to obtain encoded location information,
combine the encoded low-quality background, the encoded high-quality ROI, and the encoded location information to obtain a combined package, and
transmit the combined package to a remote endpoint.

10. The system of claim 9, wherein the video module is further configured to:
decode the encoded low-quality background to obtain a low-quality reconstructed background, and
apply a machine learning model to the low-quality reconstructed background to obtain an enhanced background.

11. The system of claim 10, wherein the video module is further configured to:
decode the encoded high-quality ROI to obtain a high-quality reconstructed ROI, and
generate a reference frame by combining, using the location information, the enhanced background and the high-quality reconstructed ROI.

12. The system of claim 11, wherein the video module is further configured to:
encode a second frame of the video feed as a modification to the reference frame to obtain an encoded second frame, wherein the second frame follows the first frame in the video feed, and
transmit, to the remote endpoint, the encoded second frame.

13. The system of claim 12, wherein the remote endpoint is configured to:
decode the encoded second frame as the modification to the reference frame to obtain the second frame, and
display, based on decoding the encoded second frame as the modification to the reference frame, the second frame.

14. The system of claim 11, wherein the video module is further configured to:
receive a request to generate an instantaneous decoder refresh (IDR) frame, wherein the video module identifies the ROI and the background in the first frame in response to receiving the request.

15. The system of claim 14, wherein the video module is further configured to:
after receiving the request, flush the contents of the reference frame buffer, and
after flushing the contents of the reference frame buffer, add the reference frame to the reference frame buffer.

16. The system of claim 9, wherein the remote endpoint is configured to:
receive the combined package comprising the encoded low-quality background, the encoded high-quality ROI, and the encoded location information,
decode the encoded low-quality background to obtain a low-quality reconstructed background,
decode the encoded high-quality ROI to obtain a high-quality reconstructed ROI, and
decoding the encoded location information to obtain the location information.

17. A method comprising:
receiving, at a remote endpoint, a package comprising an encoded low-quality background, an encoded high-quality region of interest (ROI), and encoded location information;
decoding the encoded low-quality background to obtain a low-quality reconstructed background;
applying a machine learning model to the low-quality reconstructed background to obtain an enhanced background;
decoding the encoded high-quality ROI to obtain a high-quality reconstructed ROI;
decoding the encoded location information to obtain location information; and
generating a reference frame by combining, using the location information, the enhanced background and the high-quality reconstructed ROI.

18. The method of claim 17, further comprising:
receiving, at the remote endpoint, an encoded frame;
decoding, at the remote endpoint, the encoded frame as a modification to the reference frame to obtain a decoded frame; and
displaying, at the remote endpoint, the decoded frame.

19. The method of claim 17, further comprising:
sending a request to generate an instantaneous decoder refresh (IDR) frame, wherein the package is received in response to sending the request.

20. The method of claim 19, further comprising:
after sending the request, flushing the contents of a reference frame buffer; and
after flushing the contents of the reference frame buffer, adding the reference frame to the reference frame buffer.
